(19) United States
(12) Patent Application Publication
(10) Pub. No.: US 2024/0407492 A1
(43) Pub. Date: Dec. 12, 2024

(54) ADHESIVE LATEX GARMENT PATCH

(71) Applicant: Adhere LLC, Chicago, IL (US)

(72) Inventor: Alexander Grein, Chicago, IL (US)

(73) Assignee: Adhere LLC, Chicago, IL (US)

(21) Appl. No.: 18/736,244

(22) Filed: Jun. 6, 2024

Related U.S. Application Data
(60) Provisional application No. 63/506,375, filed on Jun. 6, 2023.

(51) Int. Cl. A41H 27/00; B32B 7/06; B32B 7/12; B32B 25/08; B32B 27/30; B32B 37/24; B32B 38/00; B32B 38/16; C09J 7/24; C09J 7/30; C09J 7/40; C09J 7/50; C09J 133/04

(52) U.S. Cl. CPC A41H 27/00; B32B 7/06; B32B 7/12; B32B 25/08; B32B 27/308; B32B 37/24; B32B 38/0004; B32B 38/162; C09J 7/24; C09J 7/30; C09J 7/401; C09J 7/50; C09J 133/04; B32B 2037/243; B32B 2255/10; B32B 2255/24; B32B 2255/26; B32B 2307/7376; B32B 2307/748; B32B 2319/00; B32B 2405/00; C09J 2400/20; C09J 2407/006; C09J 2433/00; C09J 2483/005

(57) ABSTRACT

The following disclosure relates to a flexible and stretchable garment repair patch with a rubber-based carrier and a permanent layer of adhesive used for the repair of clothing garments. The garment repair patch includes: a first layer having a first surface and a second surface; a second layer disposed onto the second surface of the first layer; a third layer disposed onto the second layer such that the second layer is between the first layer and the third layer; and a fourth layer disposed onto the third layer such that the second layer and the third layer are between the first layer and the fourth layer. The first layer includes a rubber material, the second layer includes an adhesion-promoting primer, the third layer includes an acrylic-based adhesive, and the fourth layer includes a release liner.

### CROSS-REFERENCE TO RELATED APPLICATION

This application claims priority to and the benefit of U.S. Application Ser. No. 63/506,375 filed Jun. 6, 2023, and entitled “Adhesive Latex Garment Patch.” The entire contents of this prior filed application are hereby expressly incorporated by reference.

### TECHNICAL FIELD

The present disclosure relates to a garment patch, and in particular, a garment repair patch configured to repair clothing primarily made of rubber material.

### BACKGROUND

Clothing, garments, and fashion accessories made of rubber material often require frequent repairs due to perforations, tears, holes, or other defects. Repairing such garments typically involves messy gluing, long wait times, and tedious processes. The use of glue can be challenging, as it often results in sticky residues and uneven application. Additionally, waiting for the adhesive to dry completely can be time-consuming, adding to the inconvenience. The repair process can be further complicated by the need to carefully align and secure the materials, requiring precision and patience to achieve a satisfactory result.

One process for repairing rubber material such as latex garments involves the use of a solvent-based rubber cement adhesive. This adhesive is typically applied to the affected area of the garment using a paintbrush. The solvent (e.g., heptane, hexane, acetone, or toluene) in the adhesive causes the latex to chemically react, resulting in temporary curling and ripples in the material. The temporary curling and ripples in the material make it difficult for the material to adhere to the damaged area smoothly and evenly, often resulting in visible imperfections or a weakened repair.

Furthermore, once the latex garment has the rubber cement adhesive applied, a patch must be manually created. This involves applying rubber cement adhesive to one side of a thin latex-based sheeting material, typically between 0.2 millimeters (mm) and 0.8 mm in thickness. After applying the adhesive to both the garment and the patch, a waiting period of 5 to 10 minutes is required. This allows the solvents in the adhesive to evaporate, enabling the latex material to uncurl and return to a natural flat state. Once the solvents have sufficiently evaporated, the patch can be pressed onto the affected area needing repair. After the patch is applied, an additional waiting period of 24 hours is necessary to allow the rubber cement adhesive sufficient time to bond with the garment. Such a process is time-consuming and difficult to perform.

### SUMMARY

In one embodiment a garment repair patch is provided. The garment repair patch includes: a first layer having a first surface and a second surface; a second layer disposed onto the second surface of the first layer; a third layer disposed onto the second layer such that the second layer is between the first layer and the third layer; and a fourth layer disposed onto the third layer such that the second layer and the third layer are between the first layer and the fourth layer. The first layer includes a rubber material, the second layer includes an adhesion-promoting primer, the third layer includes an acrylic-based adhesive, and the fourth layer includes a release liner.

In another embodiment a method of manufacturing a garment repair patch is provided. The method includes: cutting rubber material in a predetermined shape to conform to a shape of a tear in a damaged garment; cleaning the cut rubber material; and securing the rubber material in place using a fixing device. The method also includes: applying an adhesion-promoting primer onto the secured rubber material; applying an adhesive glue onto the adhesion-promoting primer of the rubber material; and applying a release liner onto the adhesive glue such as to prevent the adhesive glue from sticking to other surfaces.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Exemplary embodiments are described herein with reference to the following drawings.

FIG. 1 depicts an example of various layers within a latex garment patch.

FIG. 2 depicts another example of various layers within a latex garment path.

FIG. 3 depicts an example method for manufacturing a latex garment patch.

FIG. 4 depicts an example method of repairing a garment using a latex garment patch.

While the disclosed compositions and methods are representative of embodiments in various forms, specific embodiments are illustrated in the drawings (and are hereafter described), with the understanding that the disclosure is intended to be illustrative and is not intended to limit the claim scope to the specific embodiments described and illustrated herein.

### DETAILED DESCRIPTION

Currently, there is no solution for the repair of rubber material, such as latex garments, that involves a patch with pre-applied adhesive and a backing material made of rubber-based sheets. Thus, a garment repair patch (e.g., patch, garment patch, repair patch, or the like) is provided.

The disclosed garment repair patch offers high flexibility and stretchability to match the physical properties of a rubber material (e.g., latex) garment that requires repair. The garment repair patch advantageously simplifies the repair process by eliminating the need for manual application of adhesive and reducing waiting times. This ensures seamless integration with the garment, maintaining its aesthetic and functional integrity while enhancing durability and user convenience.

In one embodiment, a garment repair patch is made of natural latex sheeting. The natural latex-based carrier matches the properties of latex clothing. This allows the patch to be shined and stretched to similar proportions to latex sheeting. Furthermore, all maintenance and cleaning remains unchanged from that of non-patched latex clothing. Other latex clothing repair patches utilizing a non-latex adhesive carrier will not match the properties of the latex clothing and will draw unwanted attention to any locations due to the material mismatch.

In another embodiment, a garment repair patch utilizes a chemical priming procedure to ensure adhesive durability while retaining the desired stretching qualities. Current clothing repair patches utilize a mesh fabric to provide additional reinforcement. However, mesh fabric is unacceptable for rubber materials such as latex as it will prevent any meaningful stretching qualities. Thus, an adhesive primer is utilized to ensure the whole repair patch holds firm and stretches appropriately even when under stress. The primer is utilized both during the manufacturing of the patch as well as during the application of the patch by the end user.

In another embodiment, a garment repair patch made of natural latex sheeting utilizes an acrylic-based adhesive. Latex is a very sensitive material and can react harshly to certain materials. This is especially true for petroleum or oil-based products which are known to cause deterioration or “dry-rotting” of the latex material. As a result, an acrylic-based adhesive is utilized in the disclosed garment repair patch. The acrylic adhesive provides shelf stability for long-term storage periods of over a year, while not causing any detrimental impacts to the latex carrier.

In another embodiment, a garment repair patch may advantageously take the form of a garment reinforcement patch. Latex clothing generally has known weak points which frequently encounter high amounts of stress and have increased incidents of tearing. These high-frequency repair areas mainly consist of the armpits, pelvic region, and the posterior of the clothing. Most latex clothing manufacturers do not provide adequate reinforcement for these areas, and thus users can use this patch as a solution to quickly provide extra strength to these high-stress areas. Thus, a latex garment repair patch may be pre-cut to a shape that allows the patch to fully cover the identified stress area. For example, a reinforcement patch can be provided in an oval shape that covers the common stress points identified in the armpits of clothing. The reinforcement patch may also take the shape of a “U”, to cover the pelvic region while placed around any zippers found in this area. This ensures a more effective bond to the location as no trial-and-error adjustments are needed on behalf of the user to ensure adequate reinforcement coverage.

In another embodiment, a garment repair patch may advantageously be compatible with rubber latex and latex that has undergone chlorination. Chlorination is the process of exposing latex-based materials to chlorine gasses. This changes the texture of the latex-based material, and reduces friction when wearing or dressing with the material. The aforementioned approach to repairing a garment using rubber cement requires the user to “rough up” or score the repair location with an abrasive material before a patch can be glued. This is because rubber cement glues cannot adhere to a smooth non-porous surface in a manner that will provide a semi-permanent repair. The adhesive latex garment patch according to the present disclosure does not require a scoring step for retaining adhesion to chlorinated garments. With the addition of primer to the garment, the latex repair patch may adhere to chlorinated materials with no noticeable effect in longevity or strength when compared to its use on non-chlorinated materials. Furthermore, synthetic latex including nitrile rubber, silicone rubber, and neoprene provides a similar surface texture to that of chlorinated rubber. This latex garment repair patch offers the same compatibility benefits for a majority of synthetic materials advertised as natural latex alternatives.

In another embodiment, use of natural latex sheeting as the adhesive carrier material allows the garment repair patch to match the properties of the garment undergoing repair. For example, natural latex sheeting is known to stretch up to 800% of its initial size before undergoing deformation. The use of natural latex sheeting as the adhesive carrier material allows the latex clothing repair patch to match the properties of the garment undergoing repair. Common repair patch carrier materials such as polyvinyl chloride (PVC) or polythene cannot provide a similar amount of stretch without permanent deformation. The latex material property can accommodate movement or stretching without compromising the bond between the patch and the clothing. Additionally, the use of a liquid adhesive primer ensures the glue will continue to stick to the latex carrier as it stretches, contracts, and encounters general use.

In another embodiment, a garment repair patch may advantageously be compatible with commercially available latex clothing shining products and dressing aids. Users of latex clothing often prefer the shiny properties of latex. Latex clothing is commonly shined using silicone-based ingredients such as dimethicone (dimethylsiloxane) or cyclomethicone (decamethylcyclopentasiloxan). The disclosed latex repair patch may retain adhesion to the garment after being coated in these shining chemicals. In addition, the patch itself will be able to match the shine of the garment after also being in contact with the listed shining chemicals. In addition, dressing aids such as talcum powder and other silicone or water-based lubricants are commonly used when wearing latex clothing. This is due to the porous texture of natural latex sheeting which is known to cause friction when in contact with skin, and thus requires a dressing aid lubricant to minimize this friction. As a result, the disclosed latex clothing repair patch is advantageously compatible with commonly used dressing aid materials without affecting adhesion strength. These dressing aid materials are usually silicone-based and include cyclopentasiloxane and dimethicone.

### Garment Repair Patch

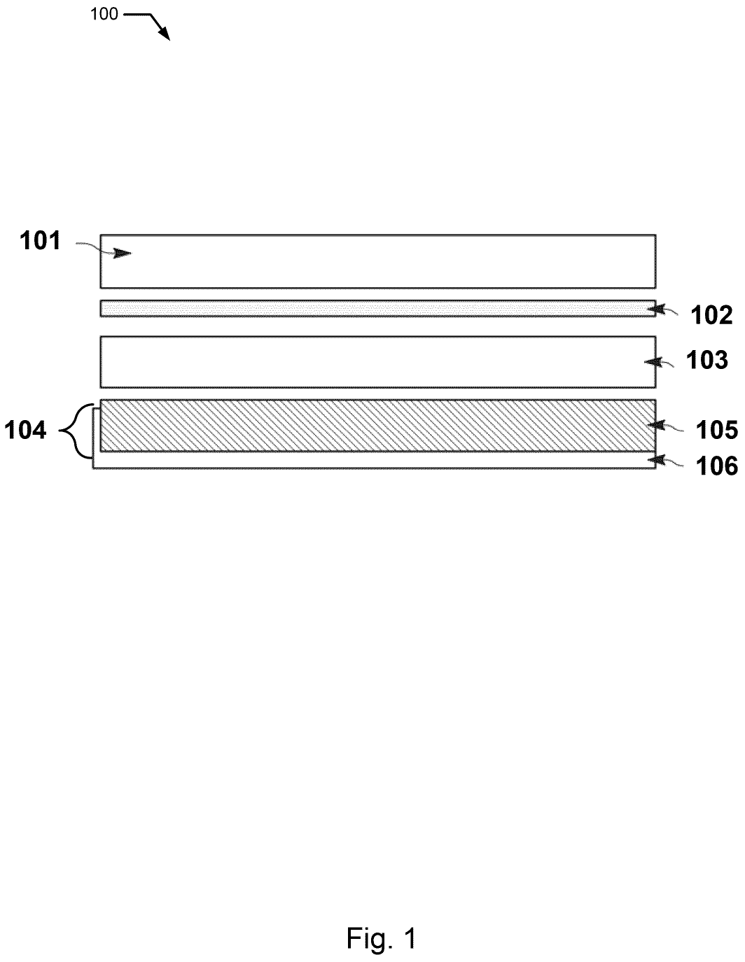

Referring to the drawings, FIG. 1 depicts an example of various layers within a garment repair patch, such as a latex patch 100. The latex patch 100 includes a first layer (i.e., a latex sheet) 101, a second layer (i.e., an adhesion-promoting primer) 102, a third layer (i.e., an acrylic-based adhesive or the like) 103, and a fourth layer (i.e., a release liner/paper/film) 104. The fourth layer 104 includes a fifth layer 105 (i.e., a silicone release coating), and a sixth layer (i.e., liner material) 106. In other words, the fourth layer 104 is comprised of two layers, a fifth layer 105 and a sixth layer 106.

As depicted in FIG. 1, a first layer 101 is provided. The first layer 101 is a rubber material that has a first surface and a second surface. The first surface of the first layer 101 is an exterior or top surface of the patch 100. The second surface of the first layer 101 is the interior or bottom surface of the patch 100 and abuts the second layer 102.

The second layer 102 is positioned on the interior surface of the first layer 101, followed by the third layer 103 disposed on the second layer 102. Furthermore, the fourth layer 104 is disposed on the third layer 103. Specifically, the fifth layer 105 of the fourth layer 104 is disposed on the third layer 103, and the sixth layer 106 of the fourth layer 104 is positioned on the fifth layer 105.

The first layer 101, as mentioned above, is a latex sheet with a thickness ranging between 0.1 millimeter (mm) to 1.0 mm. Specifically, the thickness of the latex sheet 101 may range from 0.1 mm to 0.4 mm, 0.1 mm to 0.6 mm, 0.1 mm to 0.8 mm, or 0.1 mm to 1.0 mm. In other words, thinner latex sheets (between 0.1 mm to 0.4 mm) may allow for greater flexibility and stretchability of the patch 100, but may be more prone to tearing or perforations. Thicker latex sheets (ranging from 0.4 mm to 0.8 mm) offer increased tear and puncture resistance, at the expense of reduced flexibility and stretch compared to thinner patches. Thus, the first layer 101 may vary in thickness and allow the user to choose the preferred patch properties based on the type of garment being repaired.

The first layer 101 may be made from natural rubber latex materials. Latex is natural sap commonly extracted from trees and other plants. Latex is used in the production of many consumer products and is often synonymously used to describe natural rubber materials. Latex in this context may also include synthetic materials advertised as latex substitutes including neoprene, nitrile rubber, and silicone rubber.

The first layer 101 may also act as a carrier (or backing) for the third layer 103 (i.e., the adhesive layer).

In certain examples, the first layer 101 may be provided in a variety of colors and is not limited to only one color. Thus, the first layer 101 may match the color of the garment or clothing needing repair.

In certain examples, the first layer 101 may be provided in different shapes to cover common stress points identified in the armpits of clothing. Thus, the patch 100 including all of the layers may be configured in different shapes. Such shapes include a “U” shape to cover the pelvic region while being placed around any zippers found in the area.

As depicted in FIG. 1, the second layer 102 is the adhesion-promoting primer. The second layer 102 is applied to the interior surface of the first layer 101 prior to the application of the third layer 103 (i.e., adhesive glue or the like). The second layer 102 (i.e., the adhesion-promoting primer) is shown to greatly increase the strength of the third layer 103 in its adherence to the first layer 101. The second layer 102 may be comprised of cyclohexane, xylene, ethyl alcohol, ethylbenzene, ethyl acetate, toluene, and methyl isobutyl ketone (MIBK).

In certain examples, the second layer 102 may be 3M™ Tape Primer 94. In other words, 3M™ Tape Primer 94 may be utilized as the primary adhesion-promoting primer. Only a single application of the adhesion-promoting primer is necessary to ensure a permanent bond between the first layer 101 and the third layer 103.

The third layer 103, as mentioned above, is a high-strength acrylic-based adhesive. The third layer 103 may have a caliper thickness between 0.025 mm to 0.1524 mm (i.e., 1 thousandth of an inch to 6 thousandth of an inch).

In certain examples, the third layer 103 may be 3M™ 300 and 300LSE High Strength Acrylic adhesive. The third layer 103 may be affixed to the interior of the first layer 101, on top of the second layer 102.

As mentioned above, the latex patch 100 includes a fourth layer 104. The fourth layer 104 may be a release liner. The fourth layer 104 is disposed on the third layer 103. The fourth layer 104 includes a fifth layer 105 and a sixth layer 106 that is disposed on the fifth layer 105.

Specifically, the fifth layer 105 of the fourth layer 104 is disposed on the third layer 103, and the sixth layer 106 is disposed on the fifth layer 105 of the fourth layer 104. The fourth layer 104 is configured to protect the adhesive of the third layer 103.

The fifth layer 105 of the fourth layer 104 may be a silicone release coating, disposed on the sixth layer 106, which is a liner material. The sixth layer 106 may be densified kraft paper, PET (polyethylene terephthalate), and polyester film. However, it should be noted that any liner material may be used and the sixth layer 106 is not limited to the material disclosed in the present disclosure. The fifth layer (i.e., the silicone release coating) 105 is used such that the third layer 103 does not adhere to the sixth layer (i.e., the release liner) 106. Thus, the fourth layer 104, including the fifth layer 105 and the sixth layer 106, may be removed by the user, exposing the third layer 103 prior to application onto a garment.

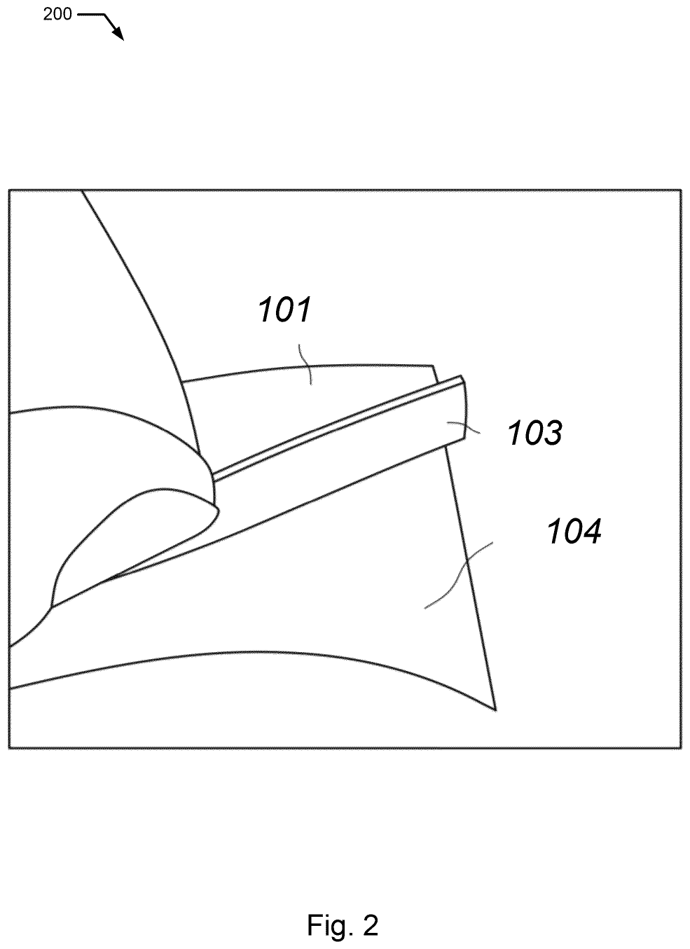

For example, FIG. 2 depicts a process of a user removing or separating the sixth layer from the patch 100 such that the patch 100 may be applied to a garment needing repair. The fourth layer (i.e., release liner) 104 is removed by the user, exposing the third layer (i.e., adhesive) 103 prior to application onto a garment.

### Method of Manufacturing A Garment Repair Patch

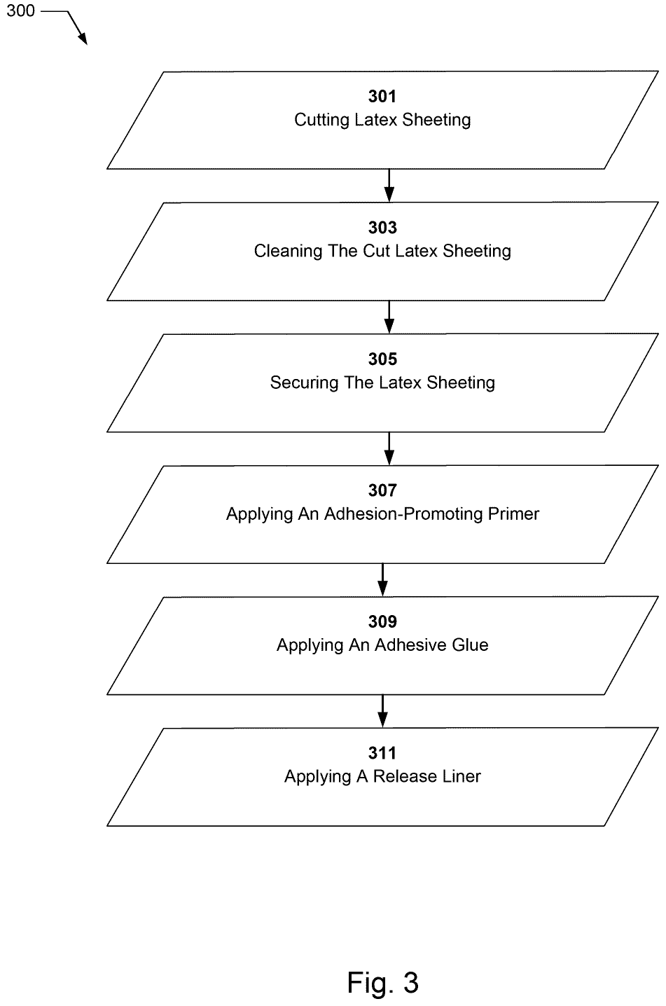

FIG. 3 depicts an example method 300 for manufacturing a garment repair patch made of rubber material such as latex. However, any rubber material may be used as the first layer 101 of the patch 100.

Manufacturing of the garment repair patch 100 is performed in four primary stages. The four stages are: cutting the latex sheeting 101, cleaning the latex sheeting 101, applying adhesion-promoting primer 102 to the latex sheeting 101, and lamination of the adhesive 103 to the latex sheeting 101 having the adhesion-promoting primer 102.

In act 301, raw latex sheeting is cut to a manageable size. Raw latex sheeting is typically 1 meter wide, and lengths vary based on the size of the roll (between 40 meters to 100 meters).

In this embodiment, the raw latex is cut to a size of about 35.56 centimeters wide and 99.06 centimeters long (i.e., 14 inches wide and 39 inches long). The cutting of the latex sheeting may be performed using a rotary cutter blade that has been attached to a slide cutter. The slide cutter includes a rotary blade which is affixed to an ABEC 5 ball bearing, and a handle which is used to apply cutting force to the latex. ABEC 5 ball bearings are precision bearings with a specific tolerance rating according to the Annular Bearing Engineers' Committee (ABEC) scale.

The rotary blade handle is affixed to a slide mechanism which allows for the entire width of the latex sheeting to be cut in a single motion. Underneath the latex sheeting is a plastic cutting mat which is used to stabilize the rotary blade and prevent blade dulling as the cut is performed.

As mentioned above, a slide mechanism is used. A slide mechanism is a mechanical system designed to move objects along a specific path or guide, usually in a linear direction. It consists of components such as rails, tracks, or guides along which a sliding element moves smoothly. The purpose of a slide mechanism is to enable controlled and precise movement, often in industrial, manufacturing, and machinery applications.

In act 303, after the latex sheeting is cut to size, the latex sheeting is cleaned. For example, raw latex sheeting is commonly packaged using talcum powder to prevent the latex from dry rotting or sticking to itself. The talcum powder must first be washed off using a cleaning agent having denatured alcohol, alkyl dimethyl amine oxide, sodium lauryl sulfate, sodium laureth sulfate, and phenoxyethanol. The latex sheeting is then soaked in water, and the cleaning solution is directly applied to the latex. A kneading process is then used to wipe off the talcum powder and any contaminants from the latex sheeting. Additionally, in certain examples, the process may include the use of a coarse rag that can apply extra friction to remove any remaining contaminants.

Upon completion of washing, a dry towel is used to immediately dry the latex sheeting. The latex sheeting may not be air dried as air drying may leave behind noticeable water spots and discoloration.

In act 305, once the latex sheeting has been cleaned and dried, the latex sheeting is secured to apply an adhesion-promoting primer. To secure the latex sheeting during the application of an adhesion-promoting primer, a fixing device is used to fix the latex sheeting in place. In one embodiment, the fixing device is a vacuum suction table, however any clamping or fixing device may be used to secure the latex sheeting from moving, curling, wrapping, and the like.

In this embodiment, the latex sheeting is placed on top of a vacuum suction table. The vacuum suction table includes a hollow rectangle box and a vacuum connected to the box such as to remove air from the interior of the box. The top surface of the vacuum suction table consists of roughly 6,550 holes over a surface of 51×20 inches. Each hole is 1.59 millimeters (i.e., 1/16 in) in diameter and is equally spaced 1 centimeter apart both horizontally and vertically. The latex sheeting is placed overtop of these holes and the vacuum is applied. This forces the latex sheeting to temporarily stick to the surface of the table while the vacuum is on. Any holes not covered by the latex are temporarily covered using painter's tape to maintain vacuum pressure on the latex material.

In act 307, an adhesion-promoting primer is then applied using a foam paint brush to the surface of the latex sheeting. This primer contains the solvents: Cyclohexane, Xylene, Ethyl Alcohol, and Ethylbenzene. These solvents react to the latex sheeting and cause curling and warping of the latex. The vacuum suction table is used to keep this sheet in a flat orientation and prevent the warping of the latex. Once the primer is applied to the latex sheeting, a period of 5 minutes should be taken to allow the primer to dry. The vacuum is to remain active this entire time to prevent any curling or warping of the latex sheeting.

In act 309, an adhesive glue is adhered onto the primed latex. The application of this adhesive glue is to be performed using a non-heated silicone lamination roller, 45.72 centimeters (i.e., 18 inches) in length. This adhesive is commercially available in a packaged roll with the silicone release coating (i.e., silicone release liner) 105 and release liner (i.e., densified kraft paper) 106 pre-attached. The roll of glue is attached to the top of the non-heated silicone lamination roller in a spool holder. The glue is partially unspooled and is manually attached to the 35.56 centimeters (i.e., 14 inches) side of primed latex. A light squeezing by hand is used to partially attach the adhesive and latex together. Once the adhesive is attached to the edge of the latex sheeting, both the adhesive and latex sheeting are fed into the lamination roller. This automatically unrolls the adhesive and provides even application pressure. Once 91 centimeters of the 99 centimeters (i.e., about 36 inches of the 39 inches) of the latex sheeting has passed through the lamination roller, the adhesive is cut using a sharp knife and the remaining portion of adhesive and latex passes through the lamination roller.

In act 311, a release liner is applied to the latex through the application of the adhesive. The release liner is carefully placed to ensure it covers the adhesive evenly, providing protection and preventing the adhesive from sticking to other surfaces until it is ready for use. This step is crucial to maintain the integrity and usability of the adhesive-coated latex sheeting.

Upon successful lamination, the garment repair patch has been manufactured.

### Method Of Repairing A Damaged Garment Using A Garment Repair Patch

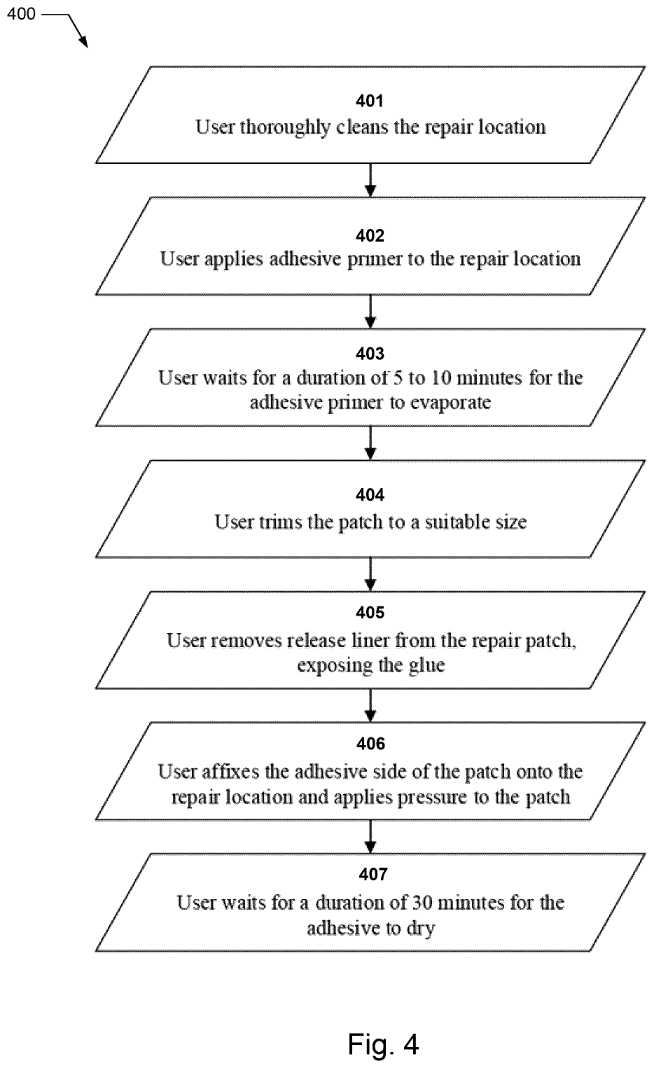

FIG. 4 depicts an example method 400 for repairing a damaged garment using a garment patch. In this embodiment, the garment repair patch 100 is made of rubber material such as latex. However, any rubber material may be used as the first layer 101 of the patch 100.

In act 401, the user must first thoroughly clean the repair location of the latex garment. This is to remove all dirt, debris, or other foreign particulates and ensure proper adhesion of the adhesive patch 100. Dish soap and water can be used for this task. However, the user may clean the repair area using a solvent such as heptane, mineral spirits, or isopropyl alcohol. A paper towel or cleaning cloth may be utilized to remove this debris.

In act 402, an adhesion promoting primer, such as adhesion-promoting primer 102 discussed above, may be used with the patch. The primer may be a fluid stored in a separate container allowing for easy dispersion by the user to the affected garment. The primer may be applied to the latex garment by the user prior to applying the patch. In its current form, this primer may be contained within a single use commercially available applicator. The user may be able to wipe the applicator over the surface of the latex garment to apply the primer. The intent of the primer is to increase the adhesion strength of the patch, while allowing the patch to remain flexible and stretchable.

For example, using adhesion promoting primer, the user applies a thin layer of adhesion promoting primer to any location of the garment intended to make contact with the patch 100. This primer is to be contained within a single use applicator which is to be disposed after use.

In act 403, after applying the primer to the desired repair location, the user must wait between 5 to 10 minutes for the primer to fully dry. However, the user is not limited to waiting between 5 to 10 minutes but may wait greater than 5 minutes, 10 minutes, 15 minutes, or more.

In act 404, upon confirming the primer has dried, the user may measure the latex clothing repair patch to ensure complete coverage of the repair area. The patch material 100 should extend at least 2 centimeters beyond the repair area on all sides to ensure that any tears or defects are securely covered, preventing further expansion of the tear. The patch can then be cut to the desired size using scissors.

In act 405, the user may peel the release liner 106 off the back of the latex clothing repair patch 100. This exposes the adhesive 103 and prepares the patch 100 for use.

In act 406, the user may press the adhesive side 103 of the patch 100 into the garment at the desired repair location. Additional force using a book or roller can be used to ensure the patch 100 is firmly pressed onto the garment.

In act 407, the user must wait at least 30 minutes for the curing period for the adhesive to securely bond with the latex material. After waiting, the garment may be worn.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

As used herein, the singular forms “a,” “an,” and “the” include plural referents unless the context clearly dictates otherwise.

As used herein, “for example,” “for instance,” “such as,” or “including” are meant to introduce examples that further clarify more general subject matter. Unless otherwise expressly indicated, such examples are provided only as an aid for understanding embodiments illustrated in the present disclosure and are not meant to be limiting in any fashion. Nor do these phrases indicate any kind of preference for the disclosed embodiment.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the disclosure. The claims should not be read as limited to the described order or elements unless stated to that effect. Therefore, all embodiments that come within the scope and spirit of the following claims and equivalents thereto are claimed as the disclosure.

1. A garment repair patch comprising:
a first layer having a first surface and a second surface, wherein the first layer includes a rubber material;
a second layer disposed onto the second surface of the first layer, wherein the second layer includes an adhesion-promoting primer;
a third layer disposed onto the second layer such that the second layer is between the first layer and the third layer, wherein the third layer includes an acrylic-based adhesive; and
a fourth layer disposed onto the third layer such that the second layer and the third layer are between the first layer and the fourth layer, wherein the fourth layer includes a release liner.

2. The garment repair patch of claim 1, further comprising an adhesion-promoting primer applicator configured to dispense and apply another adhesion-promoting primer onto an area of a damaged garment.

3. The garment repair patch of claim 1, wherein the garment repair patch is configured to be cut into any shape conforming to a tear in a damaged garment.

4. The garment repair patch of claim 1, wherein the garment repair patch is configured to adhere to chlorinated materials.

5. The garment repair patch of claim 1, wherein the rubber material has a thickness in a range of 0.1 millimeters (mm) to 1.0 mm.

6. The garment repair patch of claim 1, wherein the rubber material includes latex material, neoprene material, nitrile rubber material, or silicone rubber material.

7. The garment repair patch of claim 1, wherein the adhesion-promoting primer comprises cyclohexane, xylene, ethyl alcohol, ethylbenzene, ethyl acetate, toluene, and methyl isobutyl ketone (MIBK).

8. The garment repair patch of claim 1, wherein the acrylic-based adhesive has a thickness in a range of 0.025 millimeter (mm) to 0.2 mm.

9. The garment repair patch of claim 1, wherein the rubber material is configured to match a color of a damaged garment.

10. The garment repair patch of claim 1, wherein the fourth layer is configured to be separated from the third layer of the garment repair patch such that the third layer is exposed prior to application of the garment repair patch onto a surface of a damaged garment.

11. The garment repair patch of claim 1, wherein the fourth layer comprises a first release liner layer and a second release liner layer.

12. The garment repair patch of claim 11, wherein the first release liner layer includes a silicone release coating, and wherein the second release liner layer includes a liner material.

13. The garment repair patch of claim 12, wherein the first release liner layer is disposed on the third layer, and wherein the second release liner layer is disposed on the first release liner layer.

14. A method of manufacturing a garment repair patch, the method comprising:
cutting rubber material in a predetermined shape to conform to a shape of a tear in a damaged garment;
cleaning the cut rubber material;
securing the rubber material in place using a fixing device;
applying an adhesion-promoting primer onto the secured rubber material;
applying an adhesive glue onto the adhesion-promoting primer of the rubber material; and
applying a release liner onto the adhesive glue such as to prevent the adhesive glue from sticking to other surfaces.

15. The method of claim 14, wherein the rubber material has a thickness in a range of 0.1 millimeter (mm) to 1.0 mm.

16. The method of claim 14, wherein the rubber material includes latex material, neoprene material, nitrile rubber material, or silicone rubber material.

17. The method of claim 14, wherein the adhesion-promoting primer comprises cyclohexane, xylene, ethyl alcohol, ethylbenzene, ethyl acetate, toluene, and methyl isobutyl ketone (MIBK).

18. The method of claim 14, wherein the adhesive glue has a thickness in a range of 0.025 millimeter (mm) to 0.2 mm.

19. The method of claim 14, wherein the rubber material is configured to match a color of the damaged garment.

20. The method of claim 14, wherein the release liner includes a silicone release coating and a liner material, wherein the silicone release coating is disposed onto the adhesive glue, and wherein the liner material is disposed onto the silicone release coating.
